(19) United States
(12) Patent Application Publication
(10) Pub. No.: US 2025/0068485 A1
(43) Pub. Date: Feb. 27, 2025

(54) DEVICE RESOURCES MANAGING METHOD AND IMAGE RENDERING SYSTEM

(71) Applicant: MEDIATEK INC., Hsinchu City (TW)

(72) Inventors: Wei-Shuo CHEN, Hsinchu City (TW); Tsai-Yuan YEH, Hsinchu City (TW); Cheng-Che CHEN, Hsinchu City (TW)

(21) Appl. No.: 18/787,971

(22) Filed: Jul. 29, 2024

Related U.S. Application Data
(60) Provisional application No. 63/520,953, filed on Aug. 22, 2023.

(51) Int. Cl. G06F 9/50

(52) U.S. Cl. CPC G06F 9/5077; G06F 9/5027; G06F 2209/503

(57) ABSTRACT

A device resource provisioning method is provided. The method leverages intra-frame information to optimize device resource utilization. The method involves obtaining intra-frame information of the current frame from a running application during rendering the current frame, and adjusting the device resources provided to the running application dynamically based on the intra-frame information of the current frame.

### CROSS REFERENCE TO RELATED APPLICATIONS

This application claims the benefit of U.S. Provisional Application No. 63/520,953, filed Aug. 22, 2023, the entirety of which is incorporated by reference herein.

### BACKGROUND OF THE DISCLOSURE

### Field of the Disclosure

The present disclosure relates to device resource management, and, in particular, to a device resource managing method for use in an electronic device.

### Description of the Related Art

Increasing user demand for high Frames Per Second (FPS) in applications has become a common trend, driven by the desire for a smoother and more responsive user experience. However, achieving higher FPS often comes at a cost in power consumption, as it requires more device resources, such as, higher clock speed (or frequency) of the CPU (Central Processing Unit), GPU (Graphics Processing Unit), memory (e.g., Dynamic Random-Access Memory (DRAM), Static Random-Access Memory (SRAM), SLC (System Level Cache), L3 (level 3) cache, GPU cache) as well as a larger cache space. Consequently, there is a pressing need to strike a balance between meeting user demands of device resources and minimizing power consumption.

In the pursuit of minimized power consumption while meeting users' requirements of device resources and ensuring a positive user experience, developers strive to manage steady FPS with the least device resources. When rendering a frame, existing methods rely solely on inter-frame information to determine device resources utilization. As a result, a device (e.g., mobile phone, computer, laptop) is unable to dynamically and adaptively adjust device resources utilization based on the individual attributes and characteristics of each frame. This limitation creates a bottleneck in optimizing device resources utilization.

Therefore, it would be desirable to have a device resource managing method applied in electronic devices, to optimize device resources utilization.

### BRIEF SUMMARY OF THE DISCLOSURE

An embodiment of the present disclosure provides a device resource managing method for use in an electronic device. The method involves obtaining intra-frame information of the current frame from a running application during rendering the current frame, and adjusting device resources provided to the running application dynamically based on the intra-frame information of the current frame.

In an embodiment, the intra-frame information includes the rendering progress of the current frame. Additionally, the step of adjusting the device resources provided to the running application dynamically based on the intra-frame information of the current frame involves adjusting the clock speed of a first processing component, the clock speed of a memory component of the electronic device, or a memory space that the first processing component can use based on a comparison between the rendering progress and an expected progress.

In an embodiment, the expected progress is included in the intra-frame information.

In an embodiment, the method further includes calculating the expected progress based on the rendering progress of a specific number of previous frames preceding the current frame.

In an embodiment, the step of adjusting the device resources provided to the running application dynamically based on the intra-frame information of the current frame further involves adjusting the clock speed of a first processing component, the clock speed of a memory component of the electronic device, or a memory space that the first processing component can use based on rendering progress of the current frame. Additionally, the rendering progress is included in the intra-frame information.

In an embodiment, the intra-frame information includes a set of rendering parameters used for rendering the current frame. Additionally, the step of adjusting the device resources provided to the running application dynamically based on the intra-frame information of the current frame includes adjusting the clock speed of a first processing component, the clock speed of a memory component of the electronic device, or a memory space that the first processing component can use based on a comparison between the set of rendering parameters used for rendering the current frame to those used for rendering a specific number of previous frames preceding the current frame.

In an embodiment, the step of adjusting the device resources provided to the running application dynamically based on the intra-frame information of the current frame involves adjusting the clock speed of a first processing component, the clock speed of a memory component of the electronic device, or a memory space that the first processing component can use based on a set of rendering parameters used for rendering the current frame. The set of rendering parameters is included in the intra-frame information.

In an embodiment, the intra-frame information includes a timing parameter signifying the time required for the first processing component to wait for the second processing component to render the current frame. The step of adjusting the device resources provided to the running application dynamically based on the intra-frame information of the current frame involves adjusting the clock speed respectively for the first processing component and the second processing component based on the timing parameter, or adjusting a memory space that the first processing component and the second processing component can use based on the timing parameter. In a further embodiment, the first processing component is a central processing unit, and the second processing component is a graphics processing unit.

In an embodiment, the electronic device includes a first processing component, and the first processing component includes multiple clusters. The intra-frame information includes the running time of each of multiple threads during rendering the current frame. Each of the threads is executed by the corresponding cluster. The step of adjusting the device resources provided to the running application dynamically based on the intra-frame information of the current frame includes adjusting the clock speed for each of the clusters based on the running time of the thread executed by the corresponding cluster.

An embodiment of the present disclosure provides an image rendering system. The system includes a storage module, one or more processing components and at least one memory component, and a device resource management module. The storage module stores an application. The one or more processing components and at least one memory component are configured for running the application. The one or more processing components and the at least one memory component serve as device resources. The device resource management module is configured to obtain intra-frame information of the current frame from the running application during rendering the current frame, and adjust the device resources provided to the running application dynamically based on the intra-frame information of the current frame.

Embodiments of the device resource managing method presented in the present disclosure utilizes intra-frame information to manage device resources, enabling the image rendering system to dynamically and adaptively adjust device resources utilization based on the individual attributes and characteristics of each frame. This adaptive resource management approach allows for more precise control over resource allocation, optimizing performance and energy efficiency. By analyzing the specific needs of each frame, the system can allocate CPU, GPU, and memory resources more effectively, reducing unnecessary power consumption and enhancing overall rendering quality, and ultimately results in a more responsive and efficient rendering process, providing users with a smoother and more immersive visual experience.

### BRIEF DESCRIPTION OF THE DRAWINGS

The present disclosure can be more fully understood by reading the subsequent detailed description and examples with references made to the accompanying drawings, wherein:

FIG. 1 is a block diagram of an image rendering system, according to an embodiment of the present disclosure; and

FIG. 2 is a flow diagram of the device resource managing method used by the system illustrated in FIG. 1, according to an embodiment of the present disclosure.

### DETAILED DESCRIPTION OF THE DISCLOSURE

The following description is made for the purpose of illustrating the general principles of the disclosure and should not be taken in a limiting sense. The scope of the disclosure is best determined by reference to the appended claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

As mentioned previously, existing methods determine device resources utilization based on inter-frame information rather than intra-frame information, thus lacking the ability to dynamically and adaptively adjust device resources utilization during frame rendering of applications. However, the intra-frame information is owned by the applications rather than a device itself. In the embodiments disclosed herein, a connection (such as, an application programming interface (API)) is established between the applications and the device to facilitate the transmission and utilization of intra-frame information.

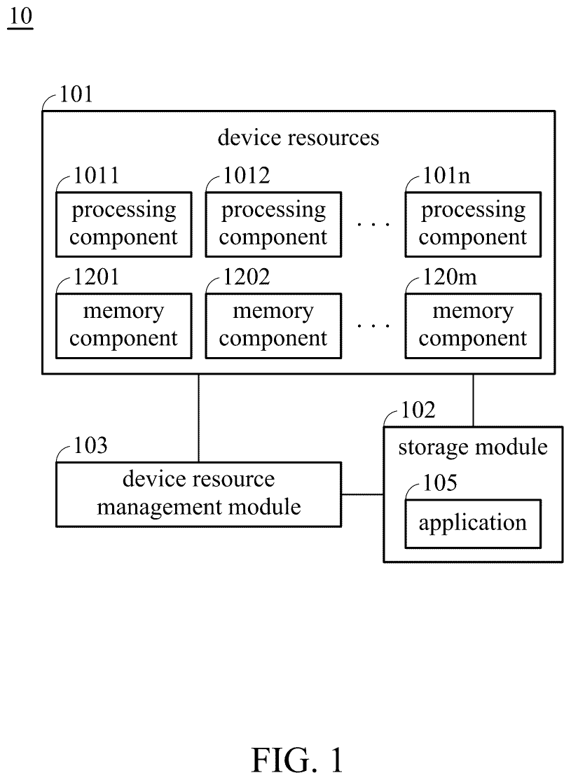

FIG. 1 is a block diagram of an image rendering system 10, according to an embodiment of the present disclosure. As shown in FIG. 1, the image rendering system 10 may include device resources 101, a storage module 102, and a device resource management module 103.

In some embodiments, the image rendering system 10 is an electronic device, such as a personal computer (e.g., desktop computer, laptop computer, tablet computer), a server computer, or a mobile device (e.g., smartphone). In other embodiments, the image rendering system 10 is a part of the electronic device.

The device resources 101refers to the resources available for performing image rendering tasks of different applications. The device resources 101 may include one or more processing components, denoted as processing components 101l-101n in FIG. 1. These processing components 101l-101n can include general or specialized processors for executing instructions related to image rendering tasks, such as Central Processing Unit (CPU), Graphics Processing Unit (GPU), Neural-network Processing Unit (NPU), microprocessor, microcontroller, Application Specific Integrated Circuit (ASIC), Field Programmable Gate Array (FPGA), System on a Chip (SoC), and/or any combination thereof, but the present disclosure is not limited thereto. In an embodiment, the device resources 101 may further include one or more memories, denoted as memory components 120l-120m in FIG. 1. These memory components 120l-120m may include Dynamic Random-Access Memory (DRAM), Static Random-Access Memory (SRAM), one or more caches, such as SLC (System Level Cache), L3 (level 3) cache, GPU cache, DynamiQ Shared Unit (DSU), and/or the combination thereof, but the present disclosure is not limited thereto. Although in FIG. 1, memory components 120l-120m are located outside the processing components 101l-101n, it should be noted that in some embodiments, memory components 120l-120m may be parts of the processing components 101l-101n. For example, each of the processing components 101l-101n can include one or more caches. In the present disclosure, the processing components 101l-101n and the memory components 120l-120m serve as device resources during performing image rendering tasks of different applications.

The storage module 102 can be any device with non-volatile memory, such as Read-Only Memory (ROM), Electrically-Erasable Programmable Read-Only Memory (EEPROM), flash memory, or Non-Volatile Random-Access Memory (NVRAM). Examples of such devices include Hard Disk Drive (HDD) arrays, Solid State Drives (SSD), or optical discs, but the present disclosure is not limited thereto.

As shown in FIG. 1, the storage module 102 stores applications, such as application 105. The application 105 may be any software program providing visualized images or video to viewers, such as a game application, a video conferencing software (e.g., Zoom, Microsoft Teams, and Google Meet), a live streaming software (e.g., Twitch, YouTube Live, and Open Broadcaster Software (OBS)), a web browser (e.g., Google Chrome, Microsoft Edge, and Safari), among others, but the present disclosure is not limited thereto. During execution, the application 105 sends function calls to the graphics driver (not shown in figure) to request the device resources 101 to render the image of the application 105. The called functions are typically provided by a graphics application interface (graphics API), such as DirectX (for Microsoft Windows), OpenGL (cross-platform), Glide (cross-platform), Metal (for MacOS or iOS), Vulkan (cross-platform), etc. In response to receiving the function calls, the graphics driver converts them into lower-level rendering instructions that are comprehensible for the bottom-layer processing components 101l-101n, and sends the rendering instructions to the processing components 101l-101n. Then, the processing components 101l-101n renders images according to the received rendering instructions.

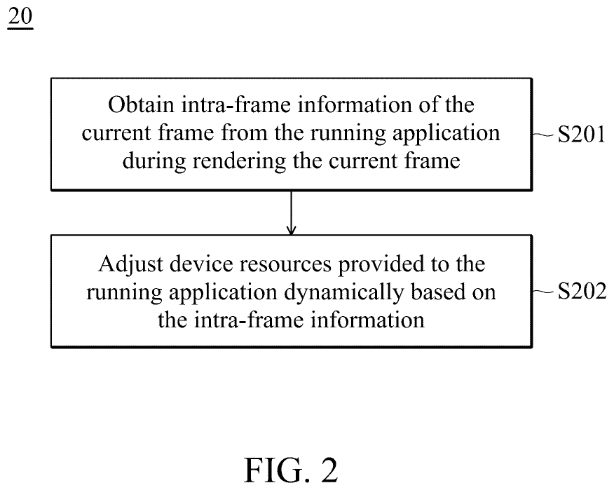

The device resource management module 103 is responsible for the managing the device resources 101 during performing the image rendering tasks of different applications. The operations of the device resource management module 103 will be described with reference to FIG. 2. The device resource management module 103 may be implemented by either a general-purpose processor or a dedicated hardware circuitry. In an embodiment where the device resource management module 103 is implemented by a general-purpose processor, such as CPU. The device resource management module 103 loads a program or an instruction set (though not shown in FIG. 1) from the storage module 102 or from at least one of the memory components 120l-120m to execute the corresponding steps of the device resource managing method 20. In another embodiment where the device resource management module 103 is implemented by a dedicated hardware circuitry, such as an application-specific integrated circuit (ASIC) or field programmable gate array (FPGA), the device resource management module 103 is configured or programmed to execute the corresponding steps of the device resource managing method 20.

FIG. 2 is a flow diagram of a device resource managing method 20 executed by the device resource management module 103, according to an embodiment of the present disclosure. As shown in FIG. 2, method 20 may include steps S201 and S202.

In step S201, intra-frame information of the current frame is obtained from a running application (such as the application 105 in FIG. 1) during rendering the current frame.

A frame refers to a snapshot of the visual content at a particular point in time during playback or rendering. In the context of the present disclosure, the term “current frame” indicates the frame that is currently being processed for display on the screen. Additionally, the term “intra-frame information” refers to the data or details specific to an individual frame within a sequence of frames. Unlike inter-frame information, which pertains to relationships or comparisons between consecutive frames, intra-frame information focuses solely on the attributes, properties, or characteristics of a single frame, which may include, for example, pixel values, object distribution, texture configuration, or other frame-specific parameters related to performance during the image rendering process.

The intra-frame information in step S201 can be obtained actively or passively through various approaches, which are not limited by the present disclosure. For example, intra-frame information can be obtained through the application programming interface (API) provided by the running application. Other types of applications 105 may also offer similar performance analysis tools, such as the Android Profiler for the Android platform, Xcode Instruments for the Xcode development environment, and Visual Studio Profiler for the Microsoft Visual Studio integrated development environment. Additionally, web browsers provide a range of Performance APIs to assist developers in measuring the performance of web applications, including Navigation Timing API and User Timing API, among others. The running application may be any software program providing visualized images or video to viewers, such as a game application, a video conferencing software (e.g., Zoom, Microsoft Teams, and Google Meet), a live streaming software (e.g., Twitch, YouTube Live, and Open Broadcaster Software (OBS)), a web browser (e.g., Google Chrome, Microsoft Edge, and Safari), among others, but the present disclosure is not limited thereto.

In step S202, device resources provided to the running application is dynamically adjusted based on the intra-frame information of the current frame.

In an embodiment, the adjustment of device resources involves adjusting the clock speed of a processing component (such as any of the processing component 101l-101n) or the clock speed of a memory component (such as any of the memory component 120l-120m) of the device. In another embodiment, the adjustment of device resources involves adjusting the memory space of the memories (such as, DRAM, SRAM, DSU, SLC, L3, GPU cache, etc.) that each of the processing component can use.

The term “clock speed” refers to the frequency at which the processing component or the memory component operates, measured in cycles per second (Hertz). An increase in the clock speed results in higher FPS but also leads to increased power consumption, while a decrease has the opposite effect. Adjusting the clock speed of the processing components or the memory components or adjusting the memory space that each of the processing component can use based on intra-frame information of the current frame enables system 10 to dynamically and adaptively adjust resources provided to the running application 105, and finally find a balance between power consumption and FPS.

As an example, in step S202, the processing component can refer to any one of the processing components 101l-101n. However, it should be noted that step S202 can adjust the clock speed of any one or more of the processing components 101l-101n, depending on the extent of each processing component's involvement in image rendering or other specific requirements. Similarly, in step S202, the memory component can refer to any one of the memory components 120l-120m. However, it should be noted that step S202 can adjust the clock speed of any one or more of the memory components 120l-120m, depending on the extent of each memory component's involvement in image rendering or other specific requirements.

In an embodiment, the intra-frame information includes the rendering progress of the current frame. Additionally, step S202 involves adjusting the clock speed of a processing component or a memory component based on a comparison between the rendering progress and the expected progress. Specifically, if the rendering progress of the current frame falls behind the expected progress, the clock speed of the processing component or the memory component is increased. Conversely, if the rendering progress of the current frame exceeds the expected progress, the clock speed of the processing component or the memory component is decreased. Alternatively, in some embodiments, a memory component may be shared by a plurality of processing components, and step S202 may involves adjusting the memory space that a processing component can use based on a comparison between the rendering progress and the expected progress.

An example is presented where the application 105 is a game application. In an embodiment, the Unity game engine divides the rendering of a frame into five stages: “Physics,” “Input,” “Game Logic,” “Scene Render,” and “UI.” The rendering progress mentioned refers to the stage the current frame has reached among these five stages. The comparison between the rendering progress and the expected progress can occur at particular points during each frame rendering process. For instance, if the expected progress at a particular point is the “Game Logic” stage, and the rendering progress is at “Physics” or “Input,” it indicates a lag behind the expected progress, necessitating an increase in clock speed of at least one processing component or memory component, and/or requiring allocating excess memory space for at least one processing component. Conversely, if the rendering progress is at “Scene Render” or “UI,” it indicates an advancement beyond the expected progress, requiring a decrease in clock speed of at least one processing component or memory component, or requiring allocating less memory space for at least one processing component. If the rendering progress falls within the “Game Logic” stage, it indicates a rough alignment with the expected progress and requires no changes in the clock speed of the processing components or memory component, and/or there is no need to change the memory space that each of the processing components can use.

It should be appreciated that different types of applications 105 may have varying definitions for running progress, distinct from those of the Unity game engine. The distinction may include, for example, differences in the number and naming of stages. Nevertheless, the underlying technical concepts remain consistent. Thus, embodiments disclosed herein are not limited to the Unity game engine example presented.

The expected progress can be obtained through various approaches. In an embodiment, the application 105 can provide the expected progress, thereby incorporating the expected progress along with the rendering progress into the intra-frame information. In another embodiment, the expected progress is calculated based on the rendering progress of a specific number of previous frames preceding the current frame. For instance, the expected progress can be derived by averaging the rendering progress of these frames. In yet another embodiment, the expected progress can be hard-coded based on specific attributes of the application 105.

In an embodiment, the intra-frame information may include the rendering progress of the current frame, and the device resource management module 103 may directly adjust the clock speed of at least one processing component or at least one memory component based on the rendering progress of the current frame or may directly adjust the memory space that at least one processing component can use based on the rendering progress of the current frame. The determination for the adjustment of the clock speed can be implemented by referring to a pre-established lookup table and interpolating between the values corresponding to the rendering progress. Alternatively, machine learning techniques, such as a pre-trained regression model, can be used to predict the optimal clock speed adjustment based on the rendering progress.

An example is presented where the application 105 is the game application mentioned before. An example of the rendering progress of the stage of a current frame may be “Game Logic” stage, it may indicate a CPU performance or a DRAM performance needs to be enhanced, and in step 202, the device resource management module 103 may directly adjust the clock speed of a CPU or the DRAM based on the rendering progress of the current frame is “Game Logic” stage, besides, the device resource management module 103 may directly increase the memory space (such as, a cache space) of a shared memory component (such as, a cache) that the CPU can use.

In an embodiment, the intra-frame information includes a set of rendering parameters used for rendering the current frame. Additionally, step S202 further involves adjusting the clock speed of at least one of the processing components or at least one of the memory components or adjusting the memory space that at least one processing component can use based on a comparison between the set of rendering parameters used for rendering the current frame to those used for rendering a specific number of previous frames preceding the current frame.

An example where the application 105 is the game application mentioned previously is presented herein. During rendering a frame of the game application, a set of rendering parameters, such as vertex count, shader object count, and object count, can be provided during the “Scene Render” stage. By comparing the rendering parameters used for rendering the current frame with those used for rendering previous frames, it is possible to predict whether the rendering load for the current frame is heavier or lighter relative to previous frames. For example, if the overall rendering parameters for the current frame, including vertex count, shader object count, and object count, are greater than those for previous frames, it can be predicted that the rendering load for the current frame is heavier, thus requiring an increase in clock speed of at least one processing component (e.g., a CPU or GPU) or at least one memory component (e.g., DRAM or SRAM) or a larger memory space (such as, the space of L3 cache or GPU cache) should be allocated to at least one processing component (e.g., a CPU or GPU). Conversely, if the overall rendering parameters for the current frame are less than those for previous frames, it can be predicted that the rendering load for the current frame is lighter, allowing for a decrease in clock speed of at least one processing component or at least one memory component or a smaller memory space (such as, the space of L3 cache or GPU cache) should be allocated to the at least one processing component. The overall assessment of rendering parameter quantity can be performed using weighted averages, where the weights may include item weights (e.g., different weights for vertex count, shader object count, and object count) and/or temporal weights (e.g., frames closer to the current frame receive higher weights), but the present disclosure is not limited thereto.

Likewise, it should be appreciated that different types of applications 105 may have varying definitions for rendering parameters, distinct from those of the Unity game engine. Therefore, embodiments disclosed herein are not limited to the Unity game engine example presented.

In an embodiment, the intra-frame information may include a set of rendering parameters used for rendering the current frame, and the device resource management module 103 may directly adjust the clock speed of at least one processing component or at least one of the memory components or directly adjust the memory space that at least one processing component can use based on these rendering parameters. The determination of the adjustment of the clock speed can be implemented by referring to a pre-established lookup table and interpolating between the values corresponding to the rendering parameters. Alternatively, machine learning techniques, such as a pre-trained regression model, can be used to predict the optimal clock speed adjustment based on the rendering parameters.

In an embodiment, the intra-frame information includes a timing parameter signifying the time required for a first processing component to wait for a second processing component to render the current frame. Additionally, step S202 may involve adjusting the clock speed respectively for the first processing component and the second processing component based on the timing parameter. In a further embodiment, the first processing component (e.g., the processing component 1011) is a CPU, and the second processing component (e.g., the processing component 1012) is a GPU.

An example where the application 105 is a game application is presented herein. In an embodiment, a timing parameter called “WaitForPresent” can be provided during the “Scene Render” stage mentioned earlier. This “WaitForPresent” parameter signifies the time required for the CPU to wait for the GPU to render the current frame. When the value of “WaitForPresent” exceeds a specified threshold, indicating a longer wait time for the CPU due to higher GPU loading, the GPU's clock speed should be increased while decreasing the CPU's clock speed. Meanwhile, the cache space of a cache (shared by the GPU and the CPU) used by the GPU should be increased and the cache space of the cache used by the CPU should be decreased. Conversely, when the value of “WaitForPresent” is small, falling below another specified threshold, indicating that the CPU is about to continue rendering work after the GPU, the CPU's clock speed can be increased while decreasing the GPU's clock speed. Similarly, the cache space of a cache (shared by the GPU and the CPU) used by the GPU should be decreased while the cache space of the cache used by the CPU should be increased.

Likewise, it should be appreciated that different types of applications 105 may have varying definitions for timing parameters, distinct from those of the Unity game engine. The distinction may include, for example, differences in the type of the first and second processing components. Therefore, embodiments disclosed herein are not limited to the Unity game engine example presented.

In an embodiment, each processing component includes multiple clusters (though not shown in FIG. 1). Additionally, the intra-frame information includes the running time of each of multiple threads during rendering the current frame. Each of the threads is executed by the corresponding cluster. Furthermore, step S202 may involve adjusting the clock speed of each of the clusters based on the running time of the thread executed by the corresponding cluster.

An example is presented where the application 105 is a game application. In an embodiment, the running time of each thread, called “UnityMainThreadTime”, is provided during the “Scene Render” stage mentioned earlier. This “UnityMainThreadTime” parameter signifies the duration for which the thread has been running. When the value of “UnityMainThreadTime” exceeds a specified threshold, indicating that the thread has been running for a prolonged period but has not completed its task due to falling behind in progress, the clock speed of the cluster corresponding to this thread should be increased. As for the other clusters, their clock speeds can be moderately decreased to allocate additional resources to the struggling thread, thereby facilitating its progress. This dynamic adjustment aims to balance the workload across different clusters, optimizing overall system performance and resource provisioning during frame rendering.

Likewise, it should be appreciated that different types of applications 105 may have varying definitions for running time of the threads, distinct from those of the Unity game engine. Therefore, embodiments disclosed herein are not limited to the Unity game engine example presented.

Embodiments of the device resource managing method presented in the present disclosure utilizes intra-frame information to manage device resources, enabling the image rendering system to dynamically and adaptively adjust device resources utilization based on the individual attributes and characteristics of each frame. This adaptive resource management approach allows for more precise control over resource allocation, optimizing performance and energy efficiency. By analyzing the specific needs of each frame, the system can allocate CPU, GPU, and memory resources more effectively, reducing unnecessary power consumption and enhancing overall rendering quality, and ultimately results in a more responsive and efficient rendering process, providing users with a smoother and more immersive visual experience.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device resource managing method, for use in an electronic device, comprising:
obtaining intra-frame information of a current frame from a running application during rendering the current frame; and
adjusting device resources provided to the running application dynamically based on the intra-frame information of the current frame.

2. The method as claimed in claim 1, wherein the intra-frame information comprises rendering progress of the current frame;
wherein adjusting the device resources provided to the running application dynamically based on the intra-frame information of the current frame comprises:
adjusting a clock speed of a first processing component, a clock speed of a memory component of the electronic device, or a memory space that the first processing component can use based on a comparison between the rendering progress and an expected progress.

3. The method as claimed in claim 2, wherein the expected progress is included in the intra-frame information.

4. The method as claimed in claim 2, further comprising:
calculating the expected progress based on the rendering progress of a specific number of previous frames preceding the current frame.

5. The method as claimed in claim 1, wherein adjusting the device resources provided to the running application dynamically based on the intra-frame information of the current frame comprises:
adjusting a clock speed of a first processing component, a clock speed of a memory component of the electronic device, or a memory space that the first processing component can use based on rendering progress of the current frame;
wherein the rendering progress is included in the intra-frame information.

6. The method as claimed in claim 1, wherein the intra-frame information comprises a set of rendering parameters used for rendering the current frame; and
wherein adjusting the device resources provided to the running application dynamically based on the intra-frame information of the current frame comprises:
adjusting a clock speed of a first processing component, a clock speed of a memory component of the electronic device, or a memory space that the first processing component can use based on a comparison between the set of rendering parameters used for rendering the current frame to those used for rendering a specific number of previous frames preceding the current frame.

7. The method as claimed in claim 1, wherein adjusting the device resources provided to the running application dynamically based on the intra-frame information of the current frame comprises:
adjusting a clock speed of a first processing component, a clock speed of a memory component of the electronic device, or a memory space that the first processing component can use based on a set of rendering parameters used for rendering the current frame;
wherein the set of rendering parameters is included in the intra-frame information.

8. The method as claimed in claim 1, wherein the intra-frame information comprises a timing parameter signifying time required for a first processing component of the electronic device to wait for a second processing component of the electronic device to render the current frame; and
wherein adjusting the device resources provided to the running application dynamically based on the intra-frame information of the current frame comprises:
adjusting a clock speed respectively for the first processing component and the second processing component based on the timing parameter; or
adjusting a memory space that the first processing component and the second processing component can use based on the timing parameter.

9. The method as claimed in claim 8, wherein the first processing component is a central processing unit, and the second processing component is a graphics processing unit.

10. The method as claimed in claim 1, wherein the electronic device comprises a first processing component, and the first processing component comprises multiple clusters;
wherein the intra-frame information comprises a running time of each of multiple threads during rendering the current frame, wherein each of the threads is executed by the corresponding cluster;
wherein adjusting the device resources provided to the running application dynamically based on the intra-frame information of the current frame comprises:
adjusting a clock speed for each of the clusters based on the running time of the thread executed by the corresponding cluster.

11. An image rendering system, comprising:
a storage module, storing an application;
one or more processing components and at least one memory component, configured for running the application, wherein the one or more processing components and the at least one memory component serve as device resources; and
a device resource management module, configured to obtain intra-frame information of a current frame from the running application during rendering the current frame, and adjust the device resources provided to the running application dynamically based on the intra-frame information of the current frame.

12. The system as claimed in claim 11, wherein the intra-frame information comprises rendering progress of the current frame;
wherein the one or more processing components comprises a first processing component; and
wherein the device resource management module is further configured to adjust a clock speed of the first processing component, a clock speed of the at least one memory component, or a memory space that the first processing component can use based on a comparison between the rendering progress and an expected progress.

13. The system as claimed in claim 12, wherein the expected progress is included in the intra-frame information.

14. The system as claimed in claim 12, wherein the device resource management module is further configured to calculate the expected progress based on the rendering progress of a specific number of previous frames preceding the current frame.

15. The system as claimed in claim 11, wherein the one or more processing components comprises a first processing component, and wherein the device resource management module is further configured to adjust a clock speed of the first processing component, a clock speed of the at least one memory component, or a memory space that the first processing component can use based on rendering progress of the current frame;
wherein the rendering progress is included in the intra-frame information.

16. The system as claimed in claim 11, wherein the one or more processing components comprises a first processing component, and wherein the intra-frame information comprises a set of rendering parameters used for rendering the current frame; and
wherein the device resource management module is further configured to adjust a clock speed of the first processing component, a clock speed of the at least one memory component, or a memory space that the first processing component can use based on a comparison between the set of rendering parameters used for rendering the current frame to those used for rendering a specific number of previous frames preceding the current frame.

17. The system as claimed in claim 11, wherein the one or more processing components comprises a first processing component, and wherein the device resource management module is further configured to adjust the clock speed of the first processing component, a clock speed of the at least one memory component, or a memory space that the first processing component can use based on a set of rendering parameters used for rendering the current frame; and
wherein the set of rendering parameters is included in the intra-frame information.

18. The system as claimed in claim 11, wherein the one or more processing components comprises a first processing component and a second processing component;
wherein the intra-frame information comprises a timing parameter signifying time required for the first processing component to wait for the second processing component to render the current frame; and
wherein the device resource management module is further configured to adjust a clock speed respectively for the first processing component and the second processing component based on the timing parameter, or adjust a memory space that the first processing component and the second processing component can use based on the timing parameter.

19. The system as claimed in claim 18, wherein the first processing component is a central processing unit, and the second processing component is a graphics processing unit.

20. The method as claimed in claim 11, wherein the one or more processing components comprises a first processing component, and the first processing component comprises multiple clusters;
wherein the intra-frame information comprises a running time of each of multiple threads during rendering the current frame, wherein each of the threads is executed by the corresponding cluster;
wherein the device resource management module is further configured to adjust a clock speed for each of the clusters based on the running time of the thread executed by the corresponding cluster.
